(19) United States
(12) Patent Application Publication
(10) Pub. No.: US 2024/0258494 A1
(43) Pub. Date: Aug. 1, 2024

(54) METHODS FOR PREPARING NEGATIVE ELECTRODES FOR ELECTROCHEMICAL CELLS

(71) Applicant: GM GLOBAL TECHNOLOGY OPERATIONS LLC, Detroit, MI (US)

(72) Inventors: Sayed Youssef Sayed NAGY, Troy, MI (US); Thomas E. MOYLAN, Dearborn Heights, MI (US); Jeffrey David CAIN, Royal Oak, MI (US); Anil K. SACHDEV, Rochester Hills, MI (US)

(73) Assignee: GM GLOBAL TECHNOLOGY OPERATIONS LLC, Detroit, MI (US)

(21) Appl. No.: 18/102,163

(22) Filed: Jan. 27, 2023

(51) Int. Cl. H01M 4/04; H01M 4/38; H01M 4/40; H01M 10/0525

(52) U.S. Cl. CPC H01M 4/0442; H01M 4/386; H01M 4/405; H01M 10/0525

(57) ABSTRACT

A method for preparing an electroactive material for an electrochemical cell that cycles lithium ions includes applying a potential to a first assembly that includes a first electrode and an aqueous electrolyte. The aqueous electrolyte includes a lithium salt and as the potential is applied the lithium salt disassociates forming cations and anions. The first assembly is physically separated from a second assembly by a lithium ion-conducting separator. The second assembly includes a second electrode and a non-aqueous electrolyte. The electroactive material is formed as the cations move from the first assembly through the lithium ion-conducting separator towards the second electrode.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

### SUMMARY

This section provides a general summary of the disclosure and is not a comprehensive disclosure of its full scope or all of its features.

The present disclosure relates to electrodes for electrochemical cells and methods of preparing and using the same.

For example, in various aspects, the present disclosure provides a method for preparing an electroactive material for an electrochemical cell that cycles lithium ions. The method may include applying a potential to a first assembly. The first assembly includes a first electrode and an aqueous electrolyte. The aqueous electrolyte includes a lithium salt and as the potential is applied the lithium salt disassociates forming cations and anions. The first assembly may be physically separated from a second assembly by a lithium ion-conducting separator. The second assembly may include a second electrode and a non-aqueous electrolyte. The electroactive material may be formed as the cations move from the first assembly through the lithium ion-conducting separator towards the second electrode.

In one aspect, the cations moving from the first assembly through the lithium ion-conducting separator towards the second electrode may include lithium and may form a lithium film that defines the electroactive material.

In one aspect, the second assembly may further include a precursor electroactive material and the cations moving from the first assembly through the lithium ion-conducting separator may interact with the precursor electroactive material to form the electroactive material.

In one aspect, the precursor electroactive material may include a silicon-containing electroactive material, the cations may include lithium, and the electroactive material may include a pre-lithiated silicon-containing electroactive material.

In one aspect, the first electrode may include a metal oxide selected from the group consisting of: RuO₂, TiO₂, IrO₂, PtO₂, and combinations thereof.

In one aspect, the aqueous electrolyte may be free of lithium metal and the lithium salt may be selected from the group consisting of: LiCl, LiBr, and combinations thereof.

In one aspect, the lithium ion-conducting separator may include a ceramic or glass material selected from the group consisting of: Li₂O, Al₂O₃, SiO₂, P₂O₅, TiO₂, GeO₂, and combinations thereof, and the second electrode may include a current collector material selected from the group consisting of: stainless steel, nickel, copper, carbon, and combinations thereof.

In one aspect, the non-aqueous electrolyte may include a solvent selected from the group consisting of: dimethoxyethane (DME), dioxolane (DOL), ethylene carbonate (EC), dimethyl carbonate (DMC), ethyl methyl carbonate (EMC), and combinations thereof.

In one aspect, the non-aqueous electrolyte may include an additive. The additive may be selected from the group consisting of: fluoroethylene carbonate (FEC), lithium nitrate (LiNO₃), vinylene carbonate (VC), 1,1,2,2-tetrafluoroethyle-2,2,3,3-tetrafluoropropyle ether), 1-dodecyl-methylpurroli-dinium bis(fluorosulfonyl)imide (Pyr1(12)FSI), aluminum ethoxide, and combinations thereof.

In one aspect, the second electrode may be moved through the non-aqueous electrolyte using a roll-to-roll process.

In one aspect, the anions may move towards the first electrode and may be oxidized at the first electrode to form a gas, and the first assembly may further include one or more vents for evacuating the gas.

In one aspect, at least one of the first assembly and the second assembly may further include an agitator configured to agitate the aqueous electrolyte or non-aqueous electrolyte, respectively.

In various aspects, the present disclosure provides a method for preparing an electrode assembly for an electrochemical cell that cycles lithium ions. The method may include applying a potential to a first assembly. The first assembly may include a first electrode and an aqueous electrolyte. The aqueous electrolyte may include a lithium salt and as the potential is applied the lithium salt disassociates forming cations and anions. The aqueous electrolyte may have a temperature greater than or equal to about 10° C. to less than or equal to about 25° C. The first assembly may be physically separated from a second assembly by a lithium ion-conducting separator. The second assembly may include a second electrode and a non-aqueous electrolyte. The electrode assembly may be formed as the cations move from the first assembly through the lithium ion-conducting separator and plate onto the second electrode to form a lithium film.

In one aspect, the first electrode may include a metal oxide selected from the group consisting of: RuO₂, TiO₂, IrO₂, PtO₂, and combinations thereof. The aqueous electrolyte may be free of lithium metal and the lithium salt may be selected from the group consisting of: LiCl, LiBr, and combinations thereof.

In one aspect, the second electrode may include a current collector material selected from the group consisting of: stainless steel, nickel, copper, carbon, and combinations thereof. The non-aqueous electrolyte may include a solvent selected from the group consisting of: dimethoxyethane (DME), dioxolane (DOL), ethylene carbonate (EC), dimethyl carbonate (DMC), ethyl methyl carbonate (EMC), and combinations thereof.

In one aspect, the non-aqueous electrolyte may include an additive. The additive may be selected from the group consisting of: fluoroethylene carbonate (FEC), lithium nitrate (LiNO₃), vinylene carbonate (VC), 1,1,2,2-tetrafluoroethyle-2,2,3,3-tetrafluoropropyle ether), 1-dodecyl-methylpurroli-dinium bis(fluorosulfonyl)imide (Pyr1(12)FSI), aluminum ethoxide, and combinations thereof.

In various aspects, the present disclosure provides a method for preparing an electroactive material for an electrochemical cell that cycles lithium ions. The method may include applying a potential to a first assembly. The first assembly may include a first electrode and an aqueous electrolyte. The aqueous electrolyte may include a lithium salt and as the potential is applied the lithium salt disassociates forming cations and anions. The aqueous electrolyte may have a temperature greater than or equal to about 10° C. to less than or equal to about 25° C. The first assembly may be physically separated from a second assembly by a lithium ion-conducting separator. The second assembly may include a second electrode, a non-aqueous electrolyte, and a precursor electroactive material. The electroactive material may be formed as the cations move from the first assembly through the lithium ion-conducting separator and interact with the precursor electroactive material.

In one aspect, the first electrode may include a metal oxide selected from the group consisting of: RuO₂, TiO₂, IrO₂, PtO₂, and combinations thereof. The aqueous electrolyte may be free of lithium metal and the lithium salt may be selected from the group consisting of: LiCl, LiBr, and combinations thereof.

In one aspect, the second electrode includes a current collector material selected from the group consisting of: stainless steel, nickel, copper, carbon, and combinations thereof. The non-aqueous electrolyte may include a solvent selected from the group consisting of: dimethoxyethane (DME), dioxolane (DOL), ethylene carbonate (EC), dimethyl carbonate (DMC), ethyl methyl carbonate (EMC), and combinations thereof.

In one aspect, the non-aqueous electrolyte may include an additive. The additive may be selected from the group consisting of: fluoroethylene carbonate (FEC), vinylene carbonate (VC), dioxolane (DOL), silane additives, tetrahydrofuran (THF), methyltetrahydrofuran (MTHF), hexafluorocylcotriphosphazene derivates (HFPN), and combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is an illustration of an example electrochemical cell including an electrode and electroactive material prepared in accordance with various aspects of the present disclosure;

FIG. 2 is an illustration of an example apparatus for forming an electrode including a lithium film in accordance with various aspects of the present disclosure;

FIG. 3 is a flow chart illustrating an example method for using the example apparatus illustrated in FIG. 2 to prepare an electrode in accordance with various aspects of the present disclosure;

FIG. 4 is an illustration of an example apparatus for forming an electroactive material in accordance with various aspects of the present disclosure; and

FIG. 5 is a flow chart illustrating an example method for using the example apparatus illustrated in FIG. 4 to prepare an electroactive material in accordance with various aspects of the present disclosure.

Corresponding reference numerals indicate corresponding parts throughout the several views of the drawings.

### DETAILED DESCRIPTION

Example embodiments are provided so that this disclosure will be thorough and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawing.

The present disclosure relates to electrodes for electrochemical cells and methods of preparing and using the same. The electrochemical cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

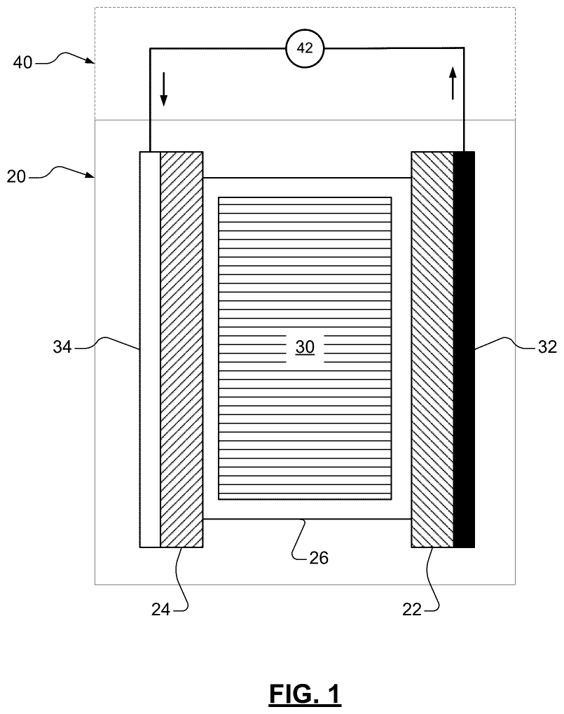

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 may include an electrolyte 30 that may, in certain aspects, also be present in the negative electrode 22 and/or the positive electrode 24, so as to form a continuous electrolyte network. In certain variations, the separator 26 may be a solid-state electrolyte or a semi-solid-state electrolyte (e.g., gel electrolyte). For example, the separator 26 may include a plurality of solid-state electrolyte particles alone or together with a liquid electrolyte, like the electrolyte 30. The positive electrode 24 and/or the negative electrode 22 may also include a plurality of solid-state electrolyte particles alone or together with a liquid electrolyte, like the electrolyte 30. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode (which can also be referred to as a negative electroactive material layer) 22. The first current collector 32 together with the negative electrode 22 may be referred to as a negative electrode assembly. Although not illustrated, the skilled artisan will appreciate that, in certain variations, negative electroactive material layers 22 may be disposed on one or more parallel sides of the first current collector 32. Similarly, the skilled artisan will appreciate that, in other variations, a negative electroactive material layer 22 may be disposed on a first side of the first current collector 32, and a positive electroactive material layer 24 may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode (which can also be referred to as a positive electroactive material layer) 24. The second current collector 34 together with the positive electrode 24 may be referred to as a positive electrode assembly. Although not illustrated, the skilled artisan will appreciate that, in certain variations, positive electroactive material layer 24 may be disposed on one or more parallel sides of the second current collector 34. Similarly, the skilled artisan will appreciate that, in other variations, a positive electroactive material layer 24 may be disposed on a first side of the second current collector 34, and a negative electroactive material layer 22 may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium-ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for the purpose of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24, may be used in the lithium-ion battery 20. For example, in certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The separator 26 may be a porous separator. For example, in certain instances, the separator 26 may be a microporous polymeric separator including, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material. The ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: NOMEX™ meta-aramid (e.g., an aromatic polyamide formed from a condensation reaction from monomers m-phenylendiamine and isophthaloyl chloride), ARAMID aromatic polyamide, and combinations thereof.

Various conventionally available polymers and commercial products for forming the separator 26 are contemplated, as well as the many manufacturing methods that may be employed to produce such a microporous polymer separator 26. For example, in certain variations, the separator 26 may be a polyolefin-based separator including, for example, polyacetylene, propylene (PP), and/or polyethylene (PE); a cellulose separator including, for example, polyvinylidene fluoride (PVDF) member and/or a porous polyimide member; and/or a high-temperature-stable separators including, for example, polyimide (PI) nanofiber-based nonwoven members, nano-sized aluminum oxide (Al₂O₃) and poly(lithium 4-styrenesulfonate)-coated polyethylene members silicon oxide (SiO₂) coated polyethylene (PE) members, co-polyimide-coated polyethylene members, polyetherimides (PEI) (bisphenol-aceton diphthalic anhydride (BPADA) and para-phenylenediamine) members, expanded polytetrafluoroethylene reinforced polyvinylidenefluoride-hexafluoropropylene members, and/or sandwiched-structure polyvinylidene fluoride (PVDF)-poly(m-phenylene isophthalamide) (PMIA)-polyvinylidene fluoride (PVDF) members. In each instance, the separator 26 may have an average thickness greater than or equal to about 1 micrometer (μm) to less than or equal to about 50 μm, and in certain instances, optionally greater than or equal to about 1 μm to less than or equal to about 20 μm; and the electrolyte 30 may wet greater than or equal to about 5 vol. % to less than or equal to about 100 vol. %, of a total porosity of the separator 26.

In various aspects, the porous separator 26 and/or the electrolyte 30 disposed in the porous separator 26 as illustrated in FIG. 1 may be replaced with a solid-state electrolyte (“SSE”) and/or semi-solid electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24.

The solid-state electrolyte and/or semi-solid electrolyte may include a plurality of solid-state electrolyte particles. In certain variations, the electrolyte 30 may at least partially fill voids (e.g., interparticle porosity) between the solid-state electrolyte particles defining the separator 26. In each variation, the solid-state electrolyte particles may include, for example, oxide-based solid-state particles (such as garnet type solid-state particles (e.g., Li₇La₃Zr₂O₁₂ (LLZO)), perovskite type solid-state particles (e.g., Li₃ₓLa_{2/3-x}TiO₃, where 0<x<0.167), NASICON type solid-state particles (e.g., Li_{1.4}Al_{0.4}Ti_{1.6}(PO₄)₃, Li₁₊ₓAlₓGe₂₋ₓ(PO₄)₃ (where 0≤x≤2) (LAGP)), and/or LISICON type solid-state particles (e.g., Li₂₊₂ₓZn₁₋ₓGeO₄, where 0<x<1)), metal-doped or aliovalent-substituted oxide solid-state particles (such as aluminum (Al) or niobium (Nb) doped Li₇La₃Zr₂O₁₂, antimony (Sb) doped Li₇La₃Zr₂O₁₂, gallium (Ga) substituted Li₇La₃Zr₂O₁₂, chromium (Cr) and/or vanadium (V) substituted LiSn₂P₃O₁₂, and/or aluminum (Al) substituted Li_{1+x+y}AlₓTi₂₋ₓSi_{Y}P_{3-y}O₁₂ (where 0<x<2 and 0<y <3)), sulfide-based solid-state particles (such as Li₂S—P₂S₅ systems (e.g., Li₃PS₄, Li₇P₃Su, and Li_{9.6}P₃S₁₂), Li₂S—SnS₂ systems (e.g., Li₄SnS₄), Li₁₀GeP₂S₁₂ (LGPS), Li_{3.25}Ge_{0.25}P_{0.75}S₄(thio-LISICON), Li_{3.4}Si_{0.4}P_{0.6}S₄, Li₁₀GeP₂S_{11.7}O_{0.3}, lithium argyrodite (Li₆PS₅X, where X is CL, Br, or I), Li_{9.54}Si_{1.74}P_{1.44}S_{1.7}Cl_{0.3}, Li_{9.6}P₃S₁₂, Li₇P₃Su, Li₉P₃S₉O₃, Li_{1.35}Ge_{1.35}P_{1.65}S₁₂, Li_{1.35}Si_{1.35}P_{1.65}S₁₂, Li_{9.81}Sn_{0.81}P_{2.18}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.933}Sn_{0.833}As_{0.166}S₄, LiI—Li₄SnS₄, and/or Li₄SnS₄), nitride-based solid-state particles (such as Li₃N, Li₇PN₄, and/or LiSi₂N₃), hydride-based solid-state particles (such as LiBH₄, LiBH₄—LiX (where X═Cl, Br, or I), LiNH₂, Li₂NH, LiBH₄—LiNH₂, and/or Li₃AlH₆), halide-based solid-state particles (such as Li₃YCl₆, Li₃InCl₆, Li₃YBr₆, LiI, Li₂CdCl₄, Li₂MgCl₄, LiCdI₄, Li₂ZnI₄, and/or Li₃OCl), and/or borate-based solid-state particles (Li₂B₄O₇ and/or Li₂O—B₂O₃—P₂O₅).

The semi-solid electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The liquid electrolyte may be like the electrolyte 30 detailed above. In certain variations, the semi-solid or gel electrolyte may also be found in the negative electrode 22 and/or positive electrode 24.

With renewed reference to FIG. 1, the positive electrode (also referred to as the positive electroactive material layer) 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24 (i.e., within voids or spaces between the positive electroactive material particles). In certain variations, the positive electrode 24 may include a plurality of solid-state electrolyte particles dispersed with the positive electroactive material particles. The electrolyte 30 may at least partially fill voids or spaces between the positive electroactive material particles and/or the solid-state electrolyte particles. In each instance, the positive electrode 24 may have an average thickness greater than or equal to about 30 μm to less than or equal to about 500 μm, and in certain aspects, optionally greater than or equal to about 50 μm to less than or equal to about 100 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electrode 24 may be a composite electrode including a combination of positive electroactive materials. For example, the positive electrode 24 may include a first positive electroactive material and a second electroactive material. A mass ratio of the first positive electroactive material to the second positive electroactive material may be greater than or equal to about 5:95 to less than or equal to about 95:5. In certain variations, the first and second electroactive materials may be independently selected from one or more layered oxides, one or more olivine-type oxides, one or more monoclinic-type oxides, one or more spinel-type oxide, one or more tavorite, or combinations thereof.

In each variation, the positive electroactive material may lithiated prior to or after incorporating into the positive electrode 24 and/or the battery 20 to help to compensate for lithium loses during cycling, such as may result during conversion reactions and/or a cathode-electrolyte interphase (CEI) layer (not shown) on the positive electrode 24 during the first cycle, as well as ongoing lithium loss due to, for example, continuous cathode-electrolyte interphase (CEI) layer formation.

The positive electroactive material may also be optionally intermingled with an electronically conductive material (i.e., conductive additive) that provides an electron conductive path and/or a polymeric binder material that improves the structural integrity of the positive electrode 24. For example, the positive electrode 24 may include greater than or equal to about 70 wt. % to less than or equal to about 98 wt. %, and in certain aspects, optionally greater than or equal to about 80 wt. % to less than or equal to about 97 wt. %, of the positive electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electrically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), poly(vinylidene fluoride-co-hexafluoropropylene (PVdF-HFP), polytetrafluoroethylene (PTFE), polyacrylic acid (PAA), polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and/or styrene copolymers (SEBS). Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode (also referred to as a negative electroactive material layer) 22 is formed from a lithium host material that is capable of functioning as a negative terminal of a lithium-ion battery. In various aspects, the negative electrode 22 may be defined by a plurality of negative electroactive material particles. The negative electroactive material particles may be disposed in one or more layers so as to define the three-dimensional structure of the negative electrode 22. The electrolyte 30 may be introduced, for example after cell assembly, and contained within pores of the negative electrode 22 (i.e., within voids or spaces between the negative electroactive material particles). In certain variations, the negative electrode 22 may include a plurality of solid-state electrolyte particles dispersed with the negative electroactive material particles. The electrolyte 30 may at least partially fill voids or spaces between the negative electroactive material particles and/or the solid-state electrolyte particles. In each instance, the negative electrode 22 may have an average thickness greater than or equal to about 30 μm to less than or equal to about 500 μm, and in certain aspects, optionally greater than or equal to about 50 μm to less than or equal to about 100 μm.

In certain variations, the negative electroactive material particles may include silicon-containing (or silicon-based) electroactive materials. The silicon-containing electroactive materials may include silicon, lithium-silicon alloys, and other silicon-containing binary and/or ternary alloys. For example, in certain variations, the silicon-containing electroactive material may include elemental silicon (Si), various lithium silicide phases (LiₓSi_{y}, where 0<x<17 and 1<y<4), silicon nanograins embedded in a silicon oxide (SiOₓ, where 0<x<2) matrix, lithium doped silicon oxide (Li_{y}SiOₓ, where 0<x<2 and 0<y<1), and combinations thereof. The silicon-containing electroactive materials may be provided as nano-particles, nano-fibers, nano-tubes, and/or micro-particles.

In other variations, the negative electrode 22 may include one or more other alloying anode materials such as aluminum, germanium, tin, antimony, and/or bismuth). In still other variations, the negative electrode 22 may include a lithium-containing negative electroactive material, such as a lithium alloy and/or a lithium metal. For example, in certain variations, the negative electrode 22 may be defined by a lithium metal foil. In still other variations, the negative electrode 22 may include, for example only, carbonaceous negative electroactive materials (such as, graphite, hard carbon, soft carbon, and the like) and/or metallic active materials (such as tin, aluminum, magnesium, germanium, and alloys thereof, and the like).

In still other variations, the negative electrode 22 may be a composite electrode including a combination of negative electroactive materials. For example, the negative electrode 22 may include a first negative electroactive material and a second negative electroactive material. A ratio of the first negative electroactive material to the second negative electroactive material may be greater than or equal to about 5:95 to less than or equal to about 95:5. In certain variations, the first negative electroactive material may be a alloying anode material including, for example, silicon, aluminum, germanium, and/or tin; and the second negative electroactive material may include a carbonaceous material (e.g., graphite, hard carbon, and/or soft carbon). For example, in certain variations, the negative electroactive material may include a carbonaceous-silicon based composite including, for example, about 10 wt. % SiOₓ (where 0<x<2) and about 90 wt. % graphite.

In each variation, the negative electroactive material may lithiated prior to or after incorporating into the negative electrode 22 and/or the battery 20 to help to compensate for lithium loses during cycling, such as may result during conversion reactions and/or the formation of LiₓSi and/or a solid electrolyte interphase (SEI) layer (not shown) on the negative electrode 22 during the first cycle, as well as ongoing lithium loss due to, for example, continuous solid electrolyte interphase (SEI) formation.

The negative electroactive material may also be optionally intermingled with an electronically conductive material (i.e., conductive additive) that provides an electron conductive path and/or a polymeric binder material that improves the structural integrity of the negative electrode 22. For example, the negative electrode 22 may include greater than or equal to about 30 wt. % to less than or equal to about 98 wt. %, and in certain aspects, optionally greater than or equal to about 60 wt. % to less than or equal to about 95 wt. %, of the negative electroactive material; greater than or equal to 0 wt. % to less than or equal to about 30 wt. %, optionally greater than 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, optionally greater than 0 wt. % to less than or equal to about 20 wt. %, and in certain aspects, optionally greater than or equal to about 0.5 wt. % to less than or equal to about 10 wt. %, of the polymeric binder. The conductive additive and/or binder as included in the negative electrode 22 may be the same as or different from the conductive additive and/or binder as included in the positive electrode 24.

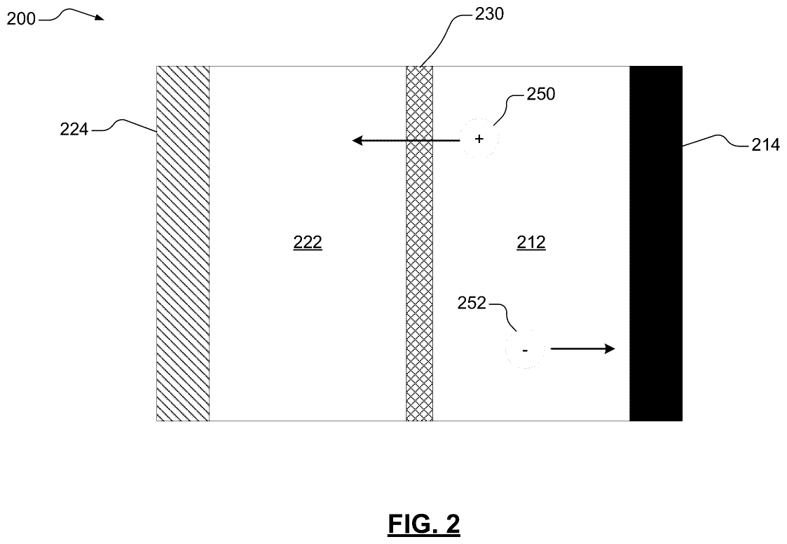

In various aspects, the present disclosure provides apparatuses and methods for forming electrodes, like the negative electrode 22 illustrated in FIG. 1. For example, in various aspects, the present disclosure provides apparatuses and methods for forming a negative electrode including a lithium film disposed on one or more surfaces of a current collector. As illustrated in FIG. 2, an example apparatus 200 for forming the negative electrode including the lithium film disposed on one or more surfaces of the current collector may be divided flow cell includes, for example, a first electrolyte tank or compartment 210 physically separated from a second electrolyte tank or compartment 220 by a lithium ion-conducting ceramic or glass separator 230, where the first electrolyte compartment 210 includes an anolyte 212, and the second electrolyte compartment 220 includes a catholyte 222. Although not illustrated, it should be recognized that, in certain variations, the first electrolyte compartment 210 and/or the second electrolyte compartment 220 may include means for agitating the anolyte 212 and catholyte 222, respectively.

The first electrolyte compartment 210 may be disposed near an anode 214. For example, as illustrated, the first electrolyte compartment 210 may be disposed between the anode 214 and the separator 230. In certain variations, the first electrolyte compartment 210 and the anode 214 may be referred to as a first assembly. Similarly, the second electrolyte compartment 220 may be disposed near a cathode 224. For example, as illustrated, the second electrolyte compartment 220 may be disposed between the cathode 224 and the separator 230. In certain variations, the second electrolyte compartment 220 and the cathode 224 may be referred to as a second assembly. The first and second assemblies may be physically separated by the lithium ion-conducting separator 230. The lithium ion-conducting ceramic or glass separator 230 may include, for example, Li₂O, Al₂O₃, SiO₂, P₂O₅, TiO₂, GeO₂, or any combination thereof. In certain variations, the separator 230 may include a ceramic or glass material selected from the group consisting of: Li₂O, Al₂O₃, SiO₂, P₂O₅, TiO₂, GeO₂, and combinations thereof.

The anode 214 may be a dimensionally stable anode. A dimensionally stable anode is an electrode that includes a high-corrosion resistance electroactive material (e.g., resistance to chlorine ions). For example, the anode 214 may include two or more metal oxides, which together have high-corrosion resistance. The two or more metal oxides may include, for example, RuO₂, TiO₂, IrO₂, PtO₂, or any combination thereof. For example, in certain variations, the two or more metal oxides may include TiO₂ as a first metal oxides and a second metal oxide selected from the group consisting of: RuO₂, IrO₂, PtO₂, and combinations thereof.

The cathode 224 may include, for example, stainless steel, nickel, copper, and/or carbon-based lithium host current collectors. For example, in one variation, the cathode 224 may include two-dimensional or three-dimensional copper. Although the cathode 224 is illustrated as being near the second electrolyte compartment 220, it should be recognized that, in certain variations, the cathode 224 may be moved through the second electrolyte compartment 220 using, for example, using a roll-to-roll process including a plurality of rollers.

The anolyte 212 may be an aqueous anolyte. More particularly, the anolyte 212 may be an aqueous anolyte free of lithium metal. The aqueous anolyte 212 may be free of lithium metal which is often expensive because of the required processes for forming the lithium metal using precursor salt. The aqueous anolyte 212 may include a first lithium salt dissolved in a first solvent. The lithium salt may be a stable lithium salt (e.g., LiCl) that dissociates into only two ions (e.g., Li⁺ and Cl⁻). For example, in certain variations, the lithium salt is a water-soluble lithium salt, such as LiCl, LiBr, or a combination of LiCl and LiBr, which are often inexpensive. The lithium salt may be selected so that the anion oxidizes at the anode 210 to form a gas (e.g., Cl⁻ →Cl₂+2e⁻). The anolyte 212 may have a lithium salt concentration greater than or equal to about 0.1 micromolar (μM) to less than or equal to about 1 molar mass (M), and in certain aspects, optionally greater than or equal to about 0.1 M to less than or equal to about 1M. The first solvent may be an aqueous solvent including water.

The catholyte 222 may be a non-aqueous catholyte that includes, for example, a second lithium salt dissolved in a second solvent. The second lithium salt is soluble in the second solvent. The second solvent may be a non-aqueous solution. In certain variations, the second solvent may be a carbonate-based non-aqueous solution or an ether-based non-aqueous solution. For example, in certain variations, the second solvent may include dimethoxyethane (DME), dioxolane (DOL), ethylene carbonate (EC), dimethyl carbonate (DMC), ethyl methyl carbonate (EMC), or any combination thereof.

In certain variations, the catholyte 222 may further include an additive. For example, the catholyte 222 may include greater than or equal to about 0.1 μM to less than or equal to about 0.5 M, and in certain aspects, optionally greater than or equal to about 0.1 M to less than or equal to about 0.5 M, of the additive. The additive may be selected to form a solid-electrolyte interphase (SEI) layer on one or more surface of the lithium film. The solid-electrolyte interphase layer may influence further lithium platting, lithium stripping, and lithium morphology during subsequent cell operation. The additive may include, for example, fluoroethylene carbonate (FEC), lithium nitrate (LiNO₃), vinylene carbonate (VC), 1,1,2,2-tetrafluoroethyle-2,2,3,3-tetrafluoropropyle ether), 1-dodecyl-methylpurroli-dinium bis(fluorosulfonyl)imide (Pyr1(12)FSI), aluminum ethoxide, or any combination thereof.

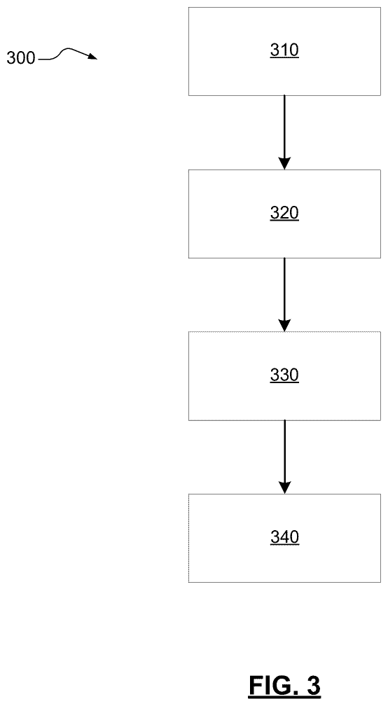

In each instance, a method 300 for preparing an electrode using the example apparatus 200 may include, as illustrated in FIG. 3, applying 310 one or more charges and/or voltages (e.g., a positive potential, positive relative to the redox potential of the anion of interest) to the apparatus 200 to initiate an electrodeposition process (i.e., potentiostat (constant voltage) or galvanostatic (constant current)), where the stable lithium salt dissociates, the cations 250 (i.e., the lithium ions (Li⁺)) move through the separator 230 and electrodeposit on one or more sides of the cathode 220 to form a lithium film, where the lithium film and the cathode 200 defining the as-formed electrode, and the anions 252 (e.g., Cl⁻) move towards the anode 210 and forms a gas. Although not illustrated, it should be recognized that, in various aspects, the apparatus 200 includes one or more vents for removing the as-formed gas (e.g., Cl⁻→Cl₂+2e⁻). The removed as-formed gas may be stored for other applications. Further, although not illustrated, it should be recognized that, in various aspects, the first electrolyte compartment 210 may be in fluid communication with one or more supplies that include fresh anolyte 212, and in particular, the stable lithium salts, such that lithium salt concentration of the anolyte is maintained above about 1 M, and the electrodeposition may continue until a desired film thickness is achieved and/or for a certain length of the cathode 220 moved through the second electrolyte compartment 220 using a roll-to-roll process. A desirable average thickness of the lithium film may be greater than or equal to about 5 μm to less than or equal to about 20 μm. In certain variations, the anolyte 212 and the catholyte 222 may have a temperature greater than or equal to about 10° C. to less than or equal to about 25° C. such that the electrodeposition process may be considered a low-temperature method. In each variation, using the electrodeposition process, lithium may be directly plated onto a current collector (i.e., the cathode 200) from a lithium salt omitting the need for lithium metal.

In various aspects, the method 300 further includes removing 320 the as-formed electrode from the catholyte 222, for example, using the roll-to-roll process, and may also further include rinsing 330 the as-formed electrode to remove any residual catholyte 422. For example, in certain variations, the as-formed electrode may be rinsed 330 with a dimethyl carbonate (DMC)-based electrolyte. The method 300 may also include aligning 340 the as-formed electrode with other cell components (e.g., positive electrode assembly and/or separator) to form (or assemble) the electrochemical cell.

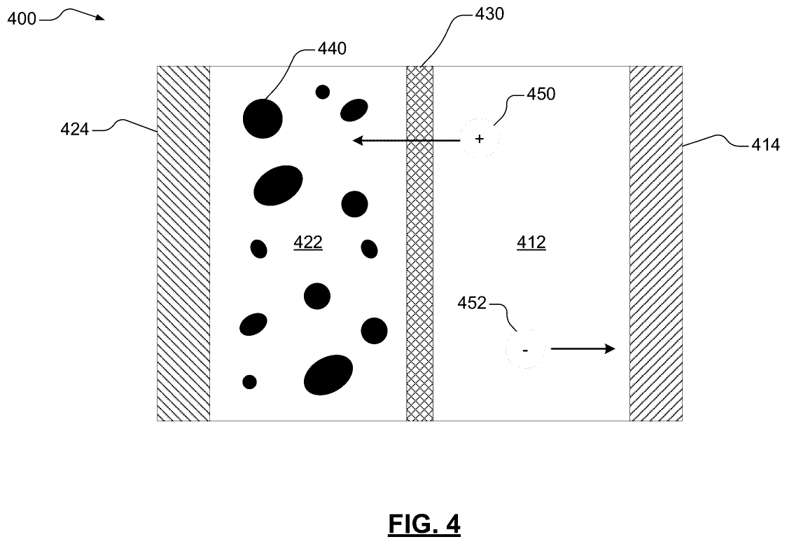

In various aspects, the present disclosure provides apparatuses and methods for preparing electroactive materials, and more particularly, for prelithiating an electroactive material, where the electroactive material includes, for example, silicon-containing negative electroactive materials and/or other negative electroactive materials and/or positive electroactive materials. For example, as illustrated in FIG. 4, an example apparatus 400 for prelithiating an electroactive material, like the example apparatus 200, may be a divided flow cell that includes a first electrolyte tank or compartment 410 physically separated from a second electrolyte tank or compartment 420 by a lithium ion-conducting ceramic or glass separator 430, where the first electrolyte compartment 410 includes an anolyte 412, and the second electrolyte compartment 420 includes a catholyte 422. Although not illustrated, it should be recognized that, in certain variations, the first electrolyte compartment 410 and/or the second electrolyte compartment 420 may include means for agitating the anolyte 412 and catholyte 422, respectively.

The first electrolyte compartment 410 may be disposed near an anode 414. For example, as illustrated, the first electrolyte compartment 410 may be disposed between the anode 414 and the separator 430. In certain variations, the first electrolyte compartment 410 and the anode 414 may be referred to as a first assembly. Similarly, the second electrolyte compartment 420 may be disposed near a cathode 424. For example, as illustrated, the second electrolyte compartment 420 may be disposed between the cathode 424 and the separator 430. In certain variations, the second electrolyte compartment 420 and the cathode 424 may be referred to as a second assembly. The first and second assemblies may be physically separated by the non-ionic separator 430.

The anode 414, like the anode 214 illustrated in FIG. 2, may be a dimensionally stable anode that may include two or more metal oxides. The two or more metal oxides may include, for example. RuO₂, TiO₂, IrO₂, PtO₂, or any combination thereof. For example, in certain variations, the anode 414 may include TiO₂ as a first metal oxides and a second metal oxide selected from the group consisting of: RuO₂, IrO₂, PtO₂, and combinations thereof.

The cathode 424, like the cathode 224 illustrated in FIG. 2, may include, for example, stainless steel, nickel, copper, and/or carbon-based lithium host current collectors. For example, in one variation, the cathode 224 may include two-dimensional or three-dimensional copper.

The anolyte 412, like the anolyte 212 illustrated in FIG. 2, may be an aqueous anolyte. More particularly, the anolyte 412 may be an aqueous anolyte free of lithium metal. The aqueous anolyte 412 may be free of lithium metal which is often expensive because of the required processes for forming the lithium metal using precursor salt. The aqueous anolyte 412 may include a first lithium salt dissolved in a first solvent. The lithium salt may be a stable lithium salt (e.g., LiCl) that dissociates into only two ions (e.g., Li⁺ and Cl⁻). For example, in certain variations, the lithium salt is a water-soluble lithium salt, such as LiCl, LiBr, or a combination of LiCl and LiBr, which are often inexpensive. The lithium salt may be selected so that the anion oxidizes at the anode 410 to form a gas (e.g., Cl⁻→Cl₂+2e⁻). The anolyte 412 may have a lithium salt concentration greater than or equal to about 0.1 μM to less than or equal to about 1 M, and in certain aspects, optionally greater than or equal to about 0.1 M to less than or equal to about 1M. The first solvent may be an aqueous solvent including water.

The catholyte 422, like the catholyte 222 illustrated in FIG. 2, may be a non-aqueous catholyte. The catholyte, however, also includes that includes a plurality of electroactive material particles (which may also be referred to as an electroactive material precursor) 440 and a second lithium salt dispersed in a second solvent. The electroactive material particles 440 may be dispersed in clusters or agglomerations or individually. The electroactive material particles 440 may include, for example, silicon or other liked materials. An average particle size (D50) of the electroactive material particles 440 may be greater than or equal to about 0.1 μm to less than or equal to about 1 μm. The second lithium salt is soluble in the second solvent. The second solvent may be a non-aqueous solution. In certain variations, the second solvent may be a carbonate-based non-aqueous solution or an ether-based non-aqueous solution. For example, in certain variations, the second solvent may include dimethoxyethane (DME), dioxolane (DOL), ethylene carbonate (EC), dimethyl carbonate (DMC), ethyl methyl carbonate (EMC), or any combination thereof.

In certain variations, like the catholyte 222 illustrated in FIG. 2, the catholyte 422 may further include an additive. For example, the catholyte 422 may include greater than or equal to about 0.1 μM to less than or equal to about 0.5 μM of the additive. The additive may be selected to form a solid-electrolyte interphase (SEI) layer on one or more surfaces of the electroactive material particles 440 (either individually or together as defining one or more agglomerates or one or more layers). The solid-electrolyte interphase layer may influence further lithium platting, lithium stripping, and lithium morphology during subsequent cell operation. The additive may include, for example, fluoroethylene carbonate (FEC), vinylene carbonate (VC), dioxolane (DOL), silane additives, tetrahydrofuran (THF), methyltetrahydrofuran (MTHF), hexafluorocylcotriphosphazene derivates (HFPN), or any combination thereof.

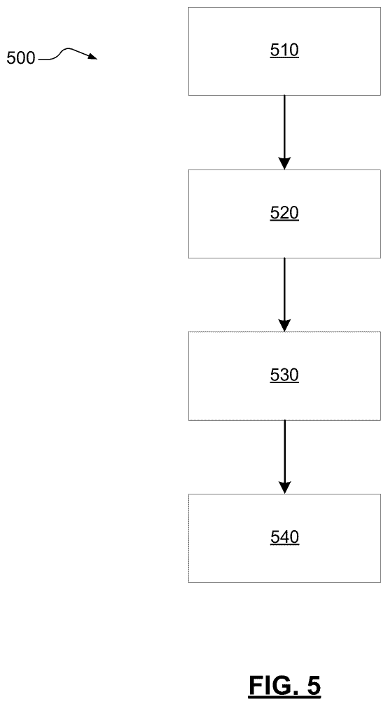

In each instance, an ex-situ method 300 for preparing an electroactive material (i.e., a pre-lithiated electroactive material) using the example apparatus 400 may include, as illustrated in FIG. 5, applying 510 one or more charges and/or voltages to the apparatus 500 to initiate a pre-lithiation process i.e., potentiostat (constant voltage) or galvanostatic (constant current)), where the stable lithium salt dissociates, the cations 450 (i.e., the lithium ions (Li⁺)) move through the separator 430 and interact with the electroactive material particles 440 to form the electroactive material (i.e., a pre-lithiated electroactive material), and the anions 452 (e.g., Cl⁻) move towards the anode 410 and forms a gas. Although not illustrated, it should be recognized that, in various aspects, the apparatus 400 includes one or more vents for removing the as-formed gas (e.g., Cl⁻→Cl₂+2e⁻). The removed as-formed gas may be stored for other applications. Further, although not illustrated, it should be recognized that, in various aspects, the first electrolyte compartment 410 may be in fluid communication with one or more supplies that include fresh anolyte 412, and in particular, the stable lithium salts, such that lithium salt concentration of the anolyte is maintained above about 1 M, and the electrodeposition may continue until a desired pre-lithiation is achieved. In certain variations, the anolyte 412 and the catholyte 422 may have a temperature greater than or equal to about 10° C. to less than or equal to about 25° C. such that the electrodeposition process may be considered a low-temperature method. In each variation, using the electroreduction process, the electroactive material may be prelithiated with the need for lithium metal.

In various aspects, the method 500 further includes removing 520 the as-formed electroactive material from the catholyte 422, and may also further include rinsing 530 the as-formed electrode to remove any residual catholyte 422. The method 500 may also include incorporating 540 the as-formed electroactive materials (i.e., the pre-lithiated electroactive materials) with other cell components (e.g., current collector and/or positive electrode assembly and/or separator) to form (or assemble) the electrochemical cell. Although not illustrated, it should be recognized that, in other variations, the as-formed electroactive material may be kept in the catholyte 422 during cell assembly, and the cathode 424 may be used as a positive electrode current collector (like the positive electrode current collector 34 illustrated in FIG. 1) and the catholyte 422 may be used as the electrolyte (like the electrolyte 20 illustrated in FIG. 1).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for preparing an electroactive material for an electrochemical cell that cycles lithium ions, the method comprising:
applying a potential to a first assembly comprising a first electrode and an aqueous electrolyte comprising a lithium salt, wherein the first assembly is physically separated from a second assembly by a lithium ion-conducting separator, the second assembly comprising a second electrode and a non-aqueous electrolyte, and wherein as the potential is applied the lithium salt disassociates forming cations and anions; and
forming the electroactive material as the cations move from the first assembly through the lithium ion-conducting separator towards the second electrode.

2. The method of claim 1, wherein the cations moving from the first assembly through the lithium ion-conducting separator towards the second electrode comprise lithium and form a lithium film that defines the electroactive material.

3. The method of claim 1, wherein the second assembly further comprises a precursor electroactive material and the cations moving from the first assembly through the lithium ion-conducting separator interact with the precursor electroactive material to form the electroactive material.

4. The method of claim 3, wherein the precursor electroactive material comprises a silicon-containing electroactive material, the cations comprise lithium, and the electroactive material comprises a pre-lithiated silicon-containing electroactive material.

5. The method of claim 1, wherein the first electrode comprises a metal oxide selected from the group consisting of: RuO₂, TiO₂, IrO₂, PtO₂, and combinations thereof.

6. The method of claim 1, wherein the aqueous electrolyte is free of lithium metal and the lithium salt is selected from the group consisting of: LiCl, LiBr, and combinations thereof.

7. The method of claim 1, wherein the lithium ion-conducting separator comprises a ceramic or glass material selected from the group consisting of: Li₂O, Al₂O₃, SiO₂, P₂O₅, TiO₂, GeO₂, and combinations thereof, and
the second electrode comprises a current collector material selected from the group consisting of: stainless steel, nickel, copper, carbon, and combinations thereof.

8. The method of claim 1, wherein the non-aqueous electrolyte comprises a solvent selected from the group consisting of: dimethoxyethane (DME), dioxolane (DOL), ethylene carbonate (EC), dimethyl carbonate (DMC), ethyl methyl carbonate (EMC), and combinations thereof.

9. The method of claim 1, wherein the non-aqueous electrolyte comprises an additive selected from the group consisting of: fluoroethylene carbonate (FEC), lithium nitrate (LiNO₃), vinylene carbonate (VC), 1,1,2,2-tetrafluoroethyle-2,2,3,3-tetrafluoropropyle ether), 1-dodecyl-methylpurroli-dinium bis(fluorosulfonyl)imide (Pyr1(12)FSI), aluminum ethoxide, and combinations thereof.

10. The method of claim 1, wherein the second electrode is moved through the non-aqueous electrolyte using a roll-to-roll process.

11. The method of claim 1, wherein the anions move towards the first electrode and are oxidized at the first electrode to form a gas, and the first assembly further comprises one or more vents for evacuating the gas.

12. The method of claim 1, wherein at least one of the first assembly and the second assembly further comprises an agitator configured to agitate the aqueous electrolyte or non-aqueous electrolyte, respectively.

13. A method for preparing an electrode assembly for an electrochemical cell that cycles lithium ions, the method comprising:
applying a potential to a first assembly comprising a first electrode and an aqueous electrolyte comprising a lithium salt and having a temperature greater than or equal to about 10° C. to less than or equal to about 25° C., wherein the first assembly is physically separated from a second assembly by a lithium ion-conducting separator, the second assembly comprising a second electrode and a non-aqueous electrolyte, and wherein as the potential is applied the lithium salt disassociates forming cations and anions; and
forming the electrode assembly as the cations move from the first assembly through the lithium ion-conducting separator and plate onto the second electrode to form a lithium film.

14. The method of claim 13, wherein the first electrode comprises a metal oxide selected from the group consisting of: RuO₂, TiO₂, IrO₂, PtO₂, and combinations thereof, and
the aqueous electrolyte is free of lithium metal and the lithium salt is selected from the group consisting of: LiCl, LiBr, and combinations thereof.

15. The method of claim 13, wherein the second electrode comprises a current collector material selected from the group consisting of: stainless steel, nickel, copper, carbon, and combinations thereof, and
the non-aqueous electrolyte comprises a solvent selected from the group consisting of: dimethoxyethane (DME), dioxolane (DOL), ethylene carbonate (EC), dimethyl carbonate (DMC), ethyl methyl carbonate (EMC), and combinations thereof.

16. The method of claim 13, wherein the non-aqueous electrolyte comprises an additive selected from the group consisting of: fluoroethylene carbonate (FEC), lithium nitrate (LiNO₃), vinylene carbonate (VC), 1,1,2,2-tetrafluoroethyle−2,2,3,3-tetrafluoropropyle ether), 1-dodecyl-methylpurroli-dinium bis(fluorosulfonyl)imide (Pyr1(12)FSI), aluminum ethoxide, and combinations thereof.

17. A method for preparing an electroactive material for an electrochemical cell that cycles lithium ions, the method comprising:
applying a potential to a first assembly comprising a first electrode and an aqueous electrolyte comprising a lithium salt and having a temperature greater than or equal to about 10° C. to less than or equal to about 25° C., wherein the first assembly is physically separated from a second assembly by a lithium ion-conducting separator, the second assembly comprising a second electrode, a non-aqueous electrolyte, and a precursor electroactive material, and wherein as the potential is applied the lithium salt disassociates forming cations and anions; and
forming the electroactive material as the cations move from the first assembly through the lithium ion-conducting separator and interact with the precursor electroactive material.

18. The method of claim 17, wherein the first electrode comprises a metal oxide selected from the group consisting of: RuO₂, TiO₂, IrO₂, PtO₂, and combinations thereof, and
wherein the aqueous electrolyte is free of lithium metal and the lithium salt is selected from the group consisting of: LiCl, LiBr, and combinations thereof.

19. The method of claim 17, wherein the second electrode comprises a current collector material selected from the group consisting of: stainless steel, nickel, copper, carbon, and combinations thereof, and
the non-aqueous electrolyte comprises a solvent selected from the group consisting of: dimethoxyethane (DME), dioxolane (DOL), ethylene carbonate (EC), dimethyl carbonate (DMC), ethyl methyl carbonate (EMC), and combinations thereof.

20. The method of claim 17, wherein the non-aqueous electrolyte comprises an additive selected from the group consisting of: fluoroethylene carbonate (FEC), vinylene carbonate (VC), dioxolane (DOL), silane additives, tetrahydrofuran (THF), methyltetrahydrofuran (MTHF), hexafluorocylcotriphosphazene derivates (HFPN), and combinations thereof.
